(19) United States
(12) Patent Application Publication
(10) Pub. No.: US 2026/0273557 A1
(43) Pub. Date: Sep. 17, 2026

(54) Power Washer Assemblies and Methods

(71) Applicant: FNA Group, Inc., Pleasant Prairie, WI (US)

(72) Inventors: Gus Alexander, Naples, FL (US); Chris Alexander, Glenview, IL (US); Richard J. Glipatrick, Burlington, WI (US); Eric D. Pederson, Kenosha, WI (US); Samuel C. Paxton, Kenosha, WI (US)

(21) Appl. No.: 19/307,251

(22) Filed: Aug. 22, 2025

Related U.S. Application Data
(63) Continuation-in-part of application No. 19/076,305, filed on Mar. 11, 2025.

(51) Int. Cl. B05B 9/04; B05B 7/00; B08B 3/02

(52) U.S. Cl. CPC B05B 9/04; B05B 7/00; B08B 3/026; B08B 2203/0205; B08B 2203/0217; B08B 2203/0241; B08B 2203/0247; B08B 2203/027; B08B 2203/0276

(57) ABSTRACT

A pressure washer assembly that is operable in multiple modalities includes a pump assembly that communicates a pressurized flow to a valve assembly. The valve assembly includes a pressure relief valve and an unloader valve assembly that are oriented in parallel relative to one another. The pressure relief valve assembly is configured to generate a first pressurized fluid flow and the unloader valve assembly is configured to generate a second fluid flow having a considerably higher pressure than a pressure associated with the first pressurized flow. A valve is disposed between an output of the pump and each of the respective pressure relief valve and unloader valve and is operable to select the cleaning mode associated with operation of the pressure washer.

### CROSS-REFERENCE TO RELATED PATENTS

This application is a Continuation-in-Part and claims priority to U.S. non-provisional patent application Ser. No. 19/076,305 filed on Mar. 11, 2025 titled POWER WASHER ASSEMBLIES AND METHODS and the disclosure of which is expressly incorporated herein.

### BACKGROUND OF THE INVENTION

The present invention generally relates to portable power or pressure washer assemblies or devices and, more specifically, to portable power washer devices that are operable in both a pressure washing modality and/or a significantly lower pressure or a soaping or soft-washing modality.

Portable power washing devices are commonly provided in constructions that are operable in distinct and separate operational modalities. In a first modality, the portable power washing devices and commonly referred to as power or pressure washer devices. Such devices commonly include a power plant such as an internal combustion engine or electric motor which is operatively connected to a fluid pump. The fluid pump is constructed to generate a fluid flow pressure downstream of the pump and which is subsequently communicated to via a hose to a gun, wand, floor scrubber, or other discharge device that is connected to the washing device and discharged via one or more tips or nozzles associated with the respective wand or output device. Actuation of a trigger associated with the wand allows the user to direct a pressurized fluid flow from the nozzle upon the material or substrate intended to be cleaned. Underlying substrates subjected to the pressurized fluid flow spray, typically at pressures above 100 psig, must be sufficiently robust to withstand the impingement of the pressurized spray during such pressurized spray mode cleaning operations without damaging the underlying substrate.

Most portable pressure washing devices utilize a flow diverting valve assembly, commonly referred to as an unloader valve assembly or simply an unloader valve, which is disposed between the pump and the discharge device. During operation of the pressure washer device, when a trigger associated with the discharge device is actuated, the unloader valve communicates a desired fluid flow pressure via a pressure hose to the discharge device. When the trigger associated with the discharge device is released, the unloader valve provides an alternate fluid flow path, commonly referred to as a bypass passage, such that operation of the power source and the fluid pump need not be interrupted but the fluid flow to the discharge device can be interrupted without overheating or over pressurizing the pump, the unloader assembly, or the discharge device and related pressure hose. Said in another way, when the pressurized fluid flow is not discharged from the discharge device, a trapped pressure is maintained between the unloader valve and a valve associated with a discharge device, and the unloader valve facilitates recirculation of a flow or a bypass flow that is communicated from the unloader valve to the pump hydraulic network and/or to a location that is upstream of an intake of the pump. Configurations wherein the bypass passage associated with the unloader valve assembly communicates the bypass fluid flow back to a positive displacement water pump maintain the desired trapped pressure between the unloader valve and the discharge device to facilitate the desired working fluid flow pressure being available at the discharge device upon actuation of the trigger associated therewith and prevent or mitigate communication of working fluid flow pressures via the hose to the discharge device.

Trapped pressure unloaders contain and hold a static water pressure that is commonly greater than a target spray pressure by use of a check valve, also known as a non-return valve. A spring associated with the unloader valve assembly is commonly compressed with an opposing force on a stem of the unloader valve assembly and is employed to meter and control the spray pressure that is communicated toward the spray nozzle when the trigger of the discharge device is actuated. The stem of the unloader valve assembly defines a valve that is engaged with a respective end of the spring of the unloader valve assembly and is operatively coupled to the hydraulic pump network to meter the pressure exerted on the system when constructed for pressure spray operations.

Commonly, when in pressure spray mode, a portion of the water flowing from the pump toward a spray nozzle is diverted back into the pump inlet water port. Typically, the unloader stem is continuously metering a portion of the flow during operation and use of the underlying pressure washer device. When in bypass mode-i.e. when the discharge flow path is unavailable, the trapped pressure between the unloader valve assembly and the pump outlet, causes the stem of the unloader to compress the spring of the unloader valve assembly such that the water flow is allowed to internally recirculate between the pump and the unloader valve assembly.

Comparatively, soap and/or soft wash cleaning is a relatively new methodology of cleaning that employs pressure or power washing devices that commonly include a pump that produces a significantly lower pressure but higher flow when compared to most traditional portable pressure washing devices. Pumps associated with soft wash washing devices are also customarily designed to handle the pumping of chemicals such as soaps, sodium hypochlorite (bleach), and other caustic cleaning chemicals employed to aid or expedite the desired cleaning process and without using high pressure water on surfaces that would otherwise be damaged if subjected to high pressure water streams. More often than not, soft wash cleaning devices also employ positive displacement pumps that are associated with an unloader valve assembly that is configured to change the flow path of water and chemicals when the trigger of the discharge device is released. Even so, assemblies constructed to effectuate soft wash operations commonly include pumps, hoses, and spray wands and/or discharge devices that are constructed to operate at significantly lower pressures and frequently greater flows than those assemblies that are constructed to facilitate high pressure washing operations.

Due to the various disparities between pressure washing devices and soft washing devices, such devices are commonly provided as dedicated machines whose operation is attenuate to the underlying washing modality intended to be employed. Similarly, the various accessories associated with pressure washing devices and soft washing devices, such as the hoses and wands or discharge devices associated with the discrete devices are also dissimilar and inapplicable for use with washing devices configured for the other washing modality. For instance, the hoses associated with pressure washing operations are commonly provided with a smaller inside diameter and ridged or robust constructions that are attenuate to withstanding the pressures associated with the pressure washing operations. The spring associated with the unloader valve assembly on pressure washing devices and the spring of the unloader valve assembly on soft washing devices commonly render the respective unloader valve assemblies unsuitable to effectuate the alternate cleaning modality. Although the respective unloader valve assemblies differ in many physical attributes, most notably, the spring rate associated with the soft wash unloader valve assembly and corresponding soft wash pump is significantly less than what would be considered suitable for operation with a pump associated with a pressure washing device.

It is similarly not economically feasible to manufacture a hose that would be suitable for operation during both pressure washing operations and soft wash operations. That is, the hoses associated with soft wash operations and pressure washing operations commonly have disparate internal diameters that are selected based on the intended use of the respective hoses and the fluid flow, chemical resistance, and flexibility they are desired to exhibit. Such devices are also commonly provided with dedicated discharge devices whose construction is likewise attenuate to the intended use and/or operation of the underlying washing device. Subjecting soft wash discharge devices to flows associated with the trapped pressures generated by pressure washer devices could potentially damage and/or render inoperable the soft wash discharge devices. The various shortcomings disclosed above have dissuaded others from attempting to provide a pressure washing device that is operable in both of a pressure washing modality and a soft wash modality such that it has become common commercial practice to offer both pressure washing devices and soft washing device as discrete unitary stand-alone devices. Unfortunately, such an approach increases the costs of users that desire to provide both pressure washing services and/or activities as well as soft wash and/or soaking or soaping service and/or activities. Such users must instead defer to owning, maintaining, storing, and transporting discrete devices that are each only operable in one of the discrete cleaning modalities.

Accordingly, there is a need for a pressure washing device that is operable in each of a pressure washing modality and a soap or soft washing modality. There is a further need for a washing device that is operable in both a pressure washing modality and soft washing modality and wherein the respective flows associated with the discrete washing modalities can be generated by a common power supply and a common pump.

### SUMMARY OF THE INVENTION

The present invention discloses a pressure washer assembly that resolves one or more of the drawbacks or shortcomings above. One aspect of the present invention discloses a pressure washer assembly that is operable in multiple modalities and includes a pump assembly that communicates a pressurized flow to an unloader valve assembly having two or more discrete unloader valve assemblies and wherein each of the at least two unloader valve assemblies are operable at discrete dissimilar working fluid flow pressures. The unloader valve assembly includes a first unloader valve assembly and a second unloader valve assembly this is downstream of the first unloader valve assembly. One of the discrete unloader valve assemblies has a higher spring pressure and is operable with a higher bypass pressure than another of the unloader valve assemblies. Said in another way, one unloader valve assembly operates at a first bypass pressure wherein another unloader valve assembly operates a second bypass pressure that is lower than the first bypass pressure. Preferably, each of the first and second unloader valve assemblies have respective valves that are operable at discrete dissimilar spring rates. The first unloader valve assembly is configured to generate a first pressurized fluid flow and the second unloader valve assembly is configured to generate a second fluid flow at a considerably lower pressure than a pressure associated with the first pressurized fluid flow. The first pressurized fluid flow is suitable for pressure washing operations whereas the second pressurized fluid flow is suitable for lower pressure or soft-wash, or soaping, operations associated with use of the underlying pressure washer assembly. A pressure washer assembly constructed in accordance with the present invention provides a pressure washer assembly that can be operated in both a pressure washing modality as well as well as a soft washing or soaping modality and avoids the user expense of owning discrete machines that are operable in only the discrete modalities and does so in a manner that allows utilization of common power source and common pump construction to generate the desired flows associated with the discrete washing methodologies or modalities. Such considerations also allow operation of the underlying pressure washing device with discrete hoses and discharge devices that are each uniquely configured to accommodate either of the pressure washing or soft or soap washing operations in a manner that does not adversely affect the operability of the underlying discharge devices and/or hoses customary thereto.

Another aspect of the invention that is useable or combinable with one or more of the features, aspects, or objects of the above aspects discloses a power washer assembly having a pump that defines a pump inlet that is connectable to a fluid supply and is configured to communicate fluid to a pump outlet during operation of the pump. A first unloader valve is disposed downstream of the pump outlet and a second unloader valve is disposed downstream of the first unloader valve. The first unloader valve and the second unloader valve are further constructed to operate at different pressures relative to one another. A first outlet is associated with the first unloader valve and is operable at a first pressure and a second outlet is associated with the second unloader valve and is operable as a second pressure that is lower than the first pressure associated with the first outlet.

A further aspect of the invention that is usable or combinable with one or more features, aspects, or objects of the above aspects discloses a pressure washer assembly having a positive displacement pump and a first unloader valve and a second unloader valve that are downstream of the positive displacement pump. The first unloader valve is connected to an output of the positive displacement pump and is configured to generate a first pressurized flow during operation of the positive displacement pump. The second unloader valve is connected downstream of the first unloader valve and is configured to generate a second pressurized flow that is different than the first pressurized flow during operation of the positive displacement pump. A valve is disposed between the first unloader valve and the second unloader valve and is selectively operable to isolate the second unloader valve from an output of the first unloader valve such that the pressure washer assembly is operable in either of a pressure washing modality and/or a soft washing or soaping modality.

Another aspect of the invention that is usable or combinable with one or more features, aspects, or objects of the above aspects discloses a method of providing a portable pressure washer assembly that is operable to generate multiple output pressures. The method includes providing a pump that is configured to communicate a fluid flow from a pump inlet to a pump outlet during operation of the pump. The pump outlet is connected to a first unloader valve that is configured to generate a first pressurized flow. An output of the first unloader valve is connected to a second unloader valve that is configured to generate a second pressurized flow that is different than the first pressurized flow such that an output of the first unloader valve can be employed for pressure washing operations and an output of the second unloader valve can be employed for soft wash and/or soaping operations.

These and other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a perspective view of a pressure washer assembly according to one embodiment of the present invention;

FIG. 2 is also a perspective view of the pressure washer assembly shown in FIG. 1 from an opposite side thereof;

FIG. 3 is a perspective view of the pressure washer assembly shown in FIG. 2 with an unloader valve assembly exposed;

FIG. 4 is a perspective view similar to FIG. 1 of a pressure washer assembly according to another embodiment of the present invention;

FIG. 5 is a perspective view of the pressure washer assembly shown in FIG. 4 from the opposing side thereof;

FIG. 6 is a perspective view of the pressure washer assembly shown in FIG. 5 with an unloader valve assembly exposed;

FIG. 7 is a perspective view of a pressure washer assembly according to another embodiment of the present invention;

FIG. 8 is a schematic representation of the pressure washer assemblies shown in FIGS. 1-3 and 7 configured for operation in a first cleaning modality;

FIG. 9 is a schematic representation similar to FIG. 8 wherein the pressure washer assembly is configured for operation in a second cleaning modality;

FIG. 10 is a schematic representation similar to FIG. 8 wherein the pressure washer assembly is configured for operation in a first cleaning modality and a second cleaning modality and is operable with respective onboard fluid solutions associated with the respective pressure washer assemblies;

FIG. 11 a perspective view similar to FIG. 1 of a power washer assembly according to another embodiment of the present invention;

FIG. 12 is a perspective similar to FIG. 2 of the power washer assembly shown in FIG. 11 with the engine and a portion of the unloader valve assembly housing removed therefrom;

FIG. 13 is a perspective view of the power washer assembly shown in FIG. 12 from an alternate perspective thereof; and

FIG. 14 is a schematic view of the pump and valve assembly of the power washer assembly shown in FIGS. 11-13.

### DETAILED DESCRIPTION

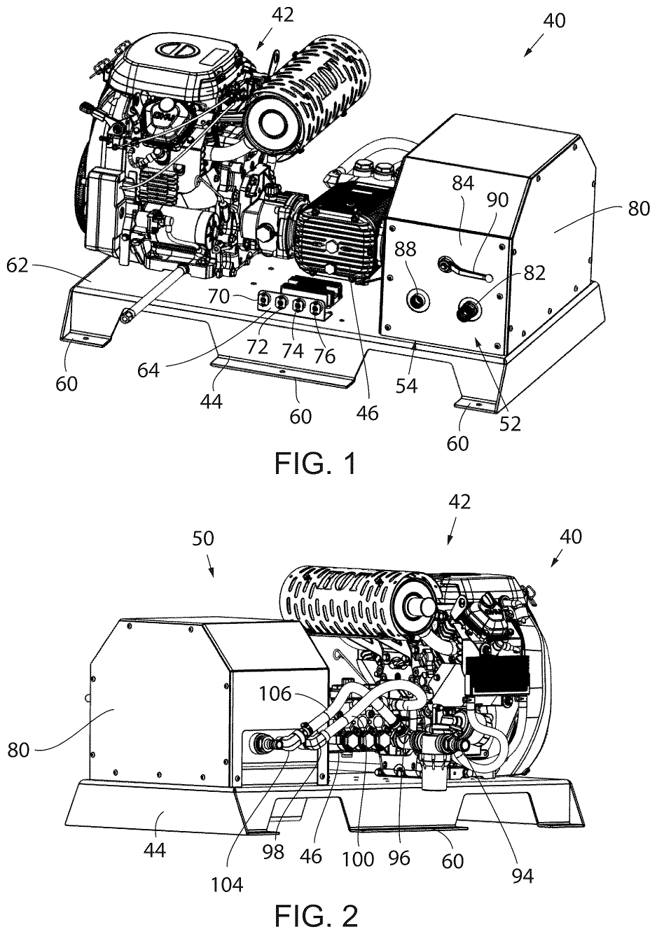

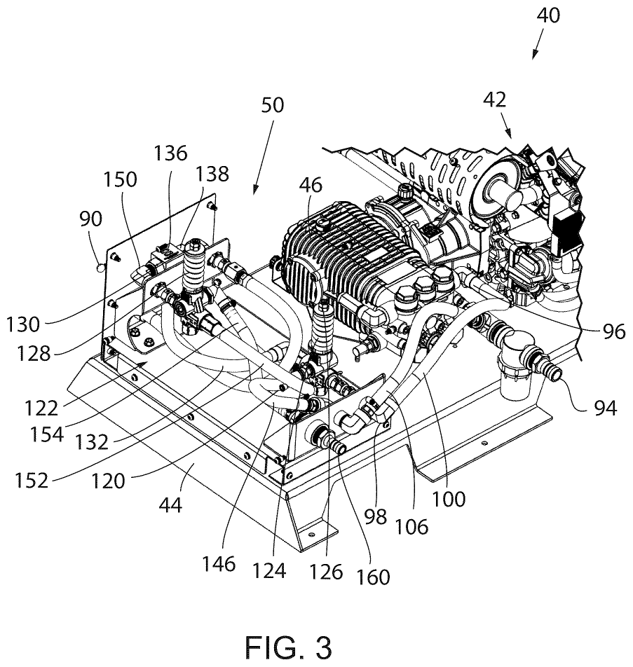

FIGS. 1-3 show various perspective views of a washing device or assembly, power washing device or assembly, or a pressure washer assembly 40 according to one embodiment of the present invention. Referring to FIGS. 1-3, pressure washer assembly 40 includes a power plant, such as motor or an internal combustion engine 42, and is supported by a chassis 44. A pump assembly, such as a positive displacement pump assembly 46, is operationally connected to an output of engine 42. As disclosed further below, pump assembly 46 includes an output or outlet that communicates a pressurized fluid flow generated by operation of engine 42 and pump assembly 46 to an unloader valve assembly 50 (FIG. 3) that is constructed to communicate discrete working fluid flows to respective outlets 52, 54 (FIG. 1) of pressure washer assembly 40. Unloader valve assembly 50 includes multiple discrete independently operable unloader valve assemblies that are operationally connected to the working fluid flow path associated with pressure washer assembly 40. As disclosed further below, outlets 52, 54 are associated with providing each of a discrete pressure washing cleaning fluid flow and a soak or soft washing cleaning fluid flow during operation of pressure washer assembly 40.

As shown in FIGS. 1 and 2, chassis 44 includes a flange 60 formed at a downwardly facing portion thereof and which is shaped to facilitate mounting a chassis 44 relative to a transport vehicle-such as upon a truck bed and/or upon a trailer to facilitate the convenient transport of pressure washer assembly 40. As disclosed further below, it is further appreciated that chassis 44 may be constructed to accommodate respective wheels and/or a handle assembly associated with manual transport of pressure washer assembly 40 when desired. Engine 42, pump assembly 46, and/or unloader valve assembly 50 are each preferably secured to an upward directed top surface 62 of chassis 44. A tip or nozzle flange 64 is secured to chassis 44 and is constructed to removably cooperate with one or more nozzles 70, 72, 74, 76 associated with utilization of a respective discharge or spray device, such as a wand or the like, during use of pressure washer assembly 40. A shroud assembly 80 generally extends about unloader valve assembly 50 and is configured to minimize incidental contact with the components thereof. Outlet 52 is generally defined by a first quick coupler 82 that is accessible through a face plate 84 of shroud assembly 80 and is constructed to provide a tool-lessly removable connection of a pressure spray hose therewith. A second quick coupler 88 is disposed proximate first quick coupler 82 and is constructed to accommodate removable connection of a soft wash hose therewith. A valve handle 90 is associated with faceplate 84 and is positioned approximate quick couplers 82, 88 and is operable to facilitate selective utilization and/or the communication of a desired working fluid flow to the respective quick connector 82, 88 associated with the high pressure washing operational modality and the soft washing operational modality during use of pressure washer assembly 40.

Referring to FIG. 2, pump assembly 46 includes an inlet 94 that is constructed to be connected to a fluid supply source as disclosed further below. As disclosed further below, it is appreciated that the fluid supply source can be provided by utility or well water supplies and/or an on-board or proximate tank supply of working water. Regardless of origin, pump assembly 46 communicates the working fluid supply flow to pump assembly 46 and which thereby communicates a pressurized fluid flow to the pump discharge outlet 96. Fluid from the pump discharge outlet 96 is communicated to an inlet 98 of unloader valve assembly 50 via a hose 100. Unloader valve assembly 50 includes a bypass outlet 104 that is connected via a hose 106 to an inlet passage associated with pump assembly 46. As disclosed further below, bypass outlet 104 of unloader valve assembly 50 facilitates recirculation of the working fluid via hose 106 from unloader valve assembly 50 to pump assembly 46 when no discharge of the working fluid flow is effectuated via either of the discrete cleaning modalities during an operation of engine 42 and pump assembly 46. Such a consideration mitigates over pressurization of pump assembly 46 and unloader assembly 50 during operation of engine 42 and during use of pressure washer assembly 40 when the pressure of the fluid flow communicated to unloader valve assembly 50 exceeds the desired output pressure associated with the utilization of pressure washing assembly 40.

Referring to FIG. 3, the output flow generated by pump assembly 46 is communicated from outlet 96 of positive displacement pump assembly 46 to inlet 98 associated with unloader valve assembly 50. Unloader valve assembly 50 includes a first unloader valve assembly or a high pressure unloader valve assembly 120 and a second unloader valve assembly 122 or a lower pressure unloader valve assembly that is downstream of unloader valve assembly 120 as disclosed further below. Each of high pressure unloader valve assembly 120 and low pressure unloader valve assembly 122 include a respective spring 124, 126 and respective stem 128, 130 that are selected and configured to be operable to allow only a preset pressure flow downstream of the respective unloader valve assemblies 120, 122 as disclosed above. High pressure unloader valve assembly 120 includes a first outlet 132 which communicates a first fluid flow pressure or pressure washing working fluid flow pressure beyond unloader valve assembly 120 to a valve assembly in the form of a three-way valve assembly or a mode selector valve 136 and whose directional operation is controlled by valve handle 90. It is appreciated that mode selector valve 136 could be provided in various constructions, such as a switching valve or a diverting valve, to effectuate the desired communication of a pressurized flow having the desired flow parameters to a respective one or each of connectors 82, 88 associated with face plate 84 as disclosed further below. When handle 90 is oriented in a first position as shown in FIG. 1, the fluid flow directed mode selector valve 136 is configured to communicate a pressurized fluid flow from a first output 138 of selector valve 136 to quick connector 82 associated with face plate 84 (FIG. 1). During non-use of the pressurized flows communicated to either of quick connector 82, 88; and/or any excess pressure flow associated with unloader valve assembly 120; such fluid is directed to pump return bypass 106 via bypass hose 146.

When soft wash operations are desired, user manipulation of handle 90 of valve assembly 136 from the orientation shown in FIG. 1 in a rotational direction allows handle 90 to achieve a second position wherein a lower pressurized fluid flow is communicated to connector 88 for use thereof for soft wash operations. Referring back to FIG. 3, when handle 90 is oriented in the second position such that pressure washer assembly 40 is configured for soft wash operations, fluid discharged from pump assembly 46 passed through high pressure unloader valve assembly 120 and is communicated to an inlet of mode selector valve 136. In such an orientation, outlet 138 of mode selector valve 136 can be fluidly isolated from the fluid flow communicated to the inlet of valve assembly 136 but fluid flow communicated to the inlet of mode selector valve 136 is communicated to a second outlet 150 of mode selector valve 136. Therefrom, the fluid flow is directed to an inlet side of low pressure unloader valve assembly 122. Fluid flow at the lower pressure flow valve associated with operation of low pressure unloader valve assembly 122 is communicated to quick connector 88 (FIG. 1) via an outlet hose 152 associated with unloader valve assembly 122 at a pressure and a flow determined thereby. Excess flow communicated to unloader valve assembly 122 travels via a bypass passage 154 to an outlet 160 associated with unloader valve assembly 50 and may be redirected therefrom to an overflow tank or the like or returned to the inlet side of pump assembly 46 for recirculation thereby. As such, pressure washer device 40 provides both high pressure washing and low pressure washing or soaping operations and does so in a manner wherein the pressure or power washing device can be conveniently and expeditiously configured for communication of the desired washing flows at parameters that are nondetrimental to the hoses, wands, and or nozzles that are connected to the discrete output connectors 82, 88 of the underlying pressure washer assembly 40. Pressure washer assembly 40 also provides pressure washing and soft washing operations with common power source and common pump assembly thereby negating the shortcomings associated with the ownership of multiple devices as disclosed above.

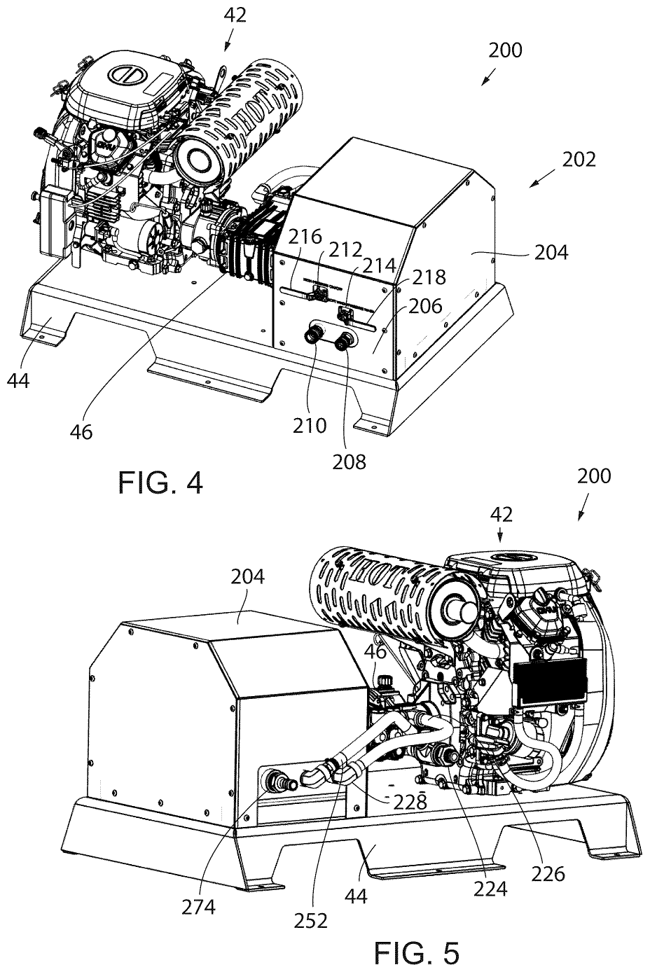

FIGS. 4-6 show another power washer device or assembly or pressure washer assembly 200 according to another embodiment to the present invention. Like pressure washer assembly 40, and referring to FIGS. 4 and 5, power washer assembly or pressure washer assembly 200 includes a power source such as an electric motor or an internal combustion engine 42 that is operationally connected to a pump assembly 46 or positive displacement pump assembly. Engine 42 and pump assembly 46 are supported by a chassis 44 that is constructed to facilitate transportation of pressure washer assembly 40. Pressure washer assembly 200 includes an unloader valve assembly 202 that is generally disposed behind a shroud 204 and that includes more than one discrete unloader valve assembly that is exposed to the working fluid flow path. Shroud 204 is partly defined by a faceplate 206 having a first output connector 208, a second output connector 210, a first mode selector valve 212, and a second mode selector valve 214, each having respective valve handles 216, 218 associated therewith. Like pressure washer assembly 40, user interaction with respective valves 212, 214 via the respective handles 216, 218 associated therewith, and connection of respective cleaning devices with connectors 210, 212, allows the user to quickly and efficiently configure pressure washer assembly 200 for high pressure washing operations and low pressure or soft wash or soaping operations when desired.

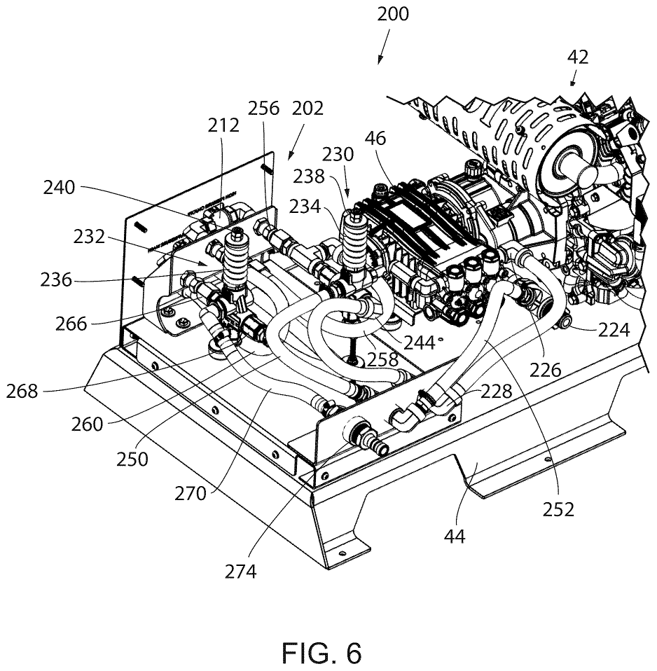

Referring to FIG. 6, pump assembly 46 includes an inlet 224 configured to be connected to a fluid supply source such a municipal or well water and/or a bulk fluid tank as disclosed further below. Pump assembly 46 includes an outlet 226 that is constructed to communicate the output of pump assembly 46 to an inlet 228 of unloader valve assembly 202. Unloader valve assembly 202 includes a first unloader valve assembly 230 and a second unloader valve assembly 232 that, like unloader valve assembly 50 of pressure washer assembly 40, each include a respective spring 234, 236, and related stem 238, 240 that are associated with the respective working fluid flows that are to be communicated downstream therefrom.

An inlet 244 of high pressure unloader valve assembly 230 is fluidly connected to outlet 226 of pump assembly 202. Unloader valve assembly 230 includes a bypass fluid flow output 250 that returns overpressure flows directed to unloader valve assembly 230 to a location upstream the inlet of pump assembly 46 via a bypass passage or hose 252. An outlet 254 of unloader valve assembly 230 directs a first fluid flow 256 to valve assembly 212 and a second fluid flow 258 to valve assembly 214. When valve assembly 212 is oriented in an “open” or “ON” orientation, first fluid flow 256 passes through valve assembly 212 at the output parameters of high pressure unloader valve assembly 230 and communicated via a hose 260 to a quick connector associated with output 208 (FIG. 4) associated with faceplate 206 such that the same can be utilized for high pressure washing operations when a suitable wand or the like is connected thereto. Orienting valve assembly 212 in a “closed” or “OFF” orientation isolates connector 208 from the fluid flow output from high pressure unloader valve assembly 230 thereby allowing selective availability of the pressurized flow transmitted therethrough.

Second fluid flow 258 communicated downstream from high pressure unloader valve assembly 230 is communicated to valve assembly 214 which is selectively operable to communicate the flow therethrough to an inlet 264 of second or low pressure unloader valve assembly 232 when valve 214 is oriented in the “ON” or “open” configuration. Second unloader valve assembly 232 allows at least a portion of the fluid communicated thereto to pass through the second unloader valve assembly 232 at the flow and pressure associated therewith. Second unloader valve assembly 232 defines a working fluid flow outlet 266 and whose flow is directed therefrom via hose 268 toward connector 210 associated with soft wash or soap operations via hose 268. Like unloader valve assembly 230, unloader valve assembly 232 includes a bypass passage 270 wherein, flows in excess of the pressure and volume associated with operation of unloader valve assembly 232 can be returned to the intake fluid flow path and/or a reservoir or other bulk source associated therewith via hose 270 and an outlet 274 associated therewith.

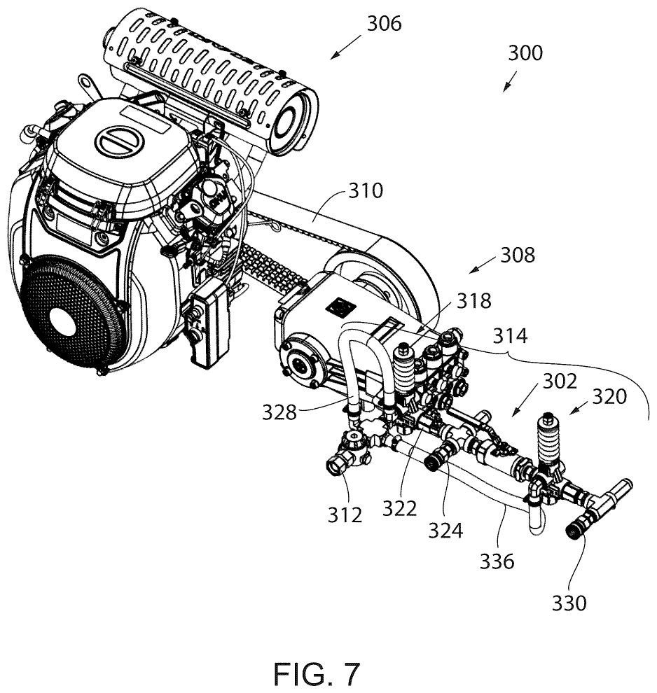

FIG. 7 shows another multiple output mode pressure washer or power washer assembly 300 according to another embodiment of the present invention. Power washer assembly 300 is somewhat similar to the pressure washer assembly 40 in that power washer assembly 300 includes a single manually operable valve assembly 302 that is selectively operable such that power washer assembly 300 can be configured for high pressure pressure washing operations and lower pressure or wash or soap washing operations. Power washer assembly 300 includes a power source such as a motor or an internal combustion engine 306 that is operationally connected to a positive displace pump assembly or simply pump assembly 308. Unlike pressure washer assemblies 40, 200, pressure washer assembly 300 includes a flexible drive member, such as a drive belt 310 that communicates an output associated with the operation of engine 306 to the pump assembly 308.

Pump assembly 308 includes a water supply inlet 312 that is fluidly connected to an inlet of pump assembly 308 and an outlet that is fluidly connected to an unloader valve assembly 314 having multiple discrete unloader valve assemblies that are operationally connected to the working fluid flow path. Unloader valve assembly 314 includes a first unloader valve assembly or a high pressure unloader valve assembly 318 that is downstream of the outlet of pump assembly 308 and a second unloader valve assembly or low pressure unloader valve assembly 320 that is down steam of first unloader valve assembly 318. First unloader valve assembly 318 defines an outlet 322 that communicates a working fluid discharged therefrom to a first output or high pressure washing quick connector 324 that is configured to accommodate connection of a high pressure washing device such a hose and related wand or gun thereto. When no demand is present, a bypass passage 328 fluidly connects a bypass outlet of first unloader valve assembly 318 to the fluid stream associated with supply inlet 312.

Operable valve assembly 302 allows selective isolation of a soft wash outlet or soft wash quick connector 330 that is oriented downstream of valve assembly 302. Second unloader valve assembly 320 is disposed between soft wash quick connector 330 and valve assembly 320 such that, when valve assembly 320 is oriented in the “ON” or “Open” configuration, only the flow and pressure associated with second unloader valve assembly 320 is available at soft wash quick connector 330. When no demand is present, a bypass passage 336 communicates the fluid flow pressure that is downstream of unloader valve assembly 320 to a location upstream of the first unloader valve assembly 318 and preferably upstream of pump assembly 308. Such considerations mitigate over pressurization of those portions of unloader valve assembly 314 that are downstream of pump assembly 308 when no demand for high pressure washing flow and low pressure washing flows are present. Although not shown, it should be further appreciated that power washing assembly 300 can be constructed to include a chassis, whether wheeled or configured to be supported to an underlying transport vehicle in the same manner as pressure washer assemblies 40, and 200 as described above.

It is further appreciated that, although each of pressure washer assemblies 40, 200, 300 disclosed above each include various respective manually operable mode selector valves 136; 212, 214; and/or 302; as indicated by the respective handles associated therewith; other control methodologies can be employed, such as electrical and servo-electrical and/or other operational modalities for instance can be employed to effectuate a desired operating modality associated with use of the underlying pressure washer assembly 40, 200, 300. Similarly, whereas each respective individual discriminate unloader valve assembly 120,122, 230, 232, 318, 320 is disclosed as being mechanically operable via the respective spring and valve stem associated therewith, it is further appreciated that one or more of the discrete unloader valve assemblies could be constructed to be electronically and servo-mechanically or electrically operable to effectuate the desired fluid flows therebeyond. It is further appreciated that one or more of pressure washer devices 40, 200, 300 could further be constructed to provide electronic or other control arrangements configured to effectuate the desired configuration of the discrete series unloader valve assemblies, the discrete unloader valve assemblies, and/or the bypass fluid flow connections associated with attaining the desired configuration of the underlying pressure washer assembly to effectuate a desired cleaning operation associated with operation thereof, and a desired direction and/or circulation of the discrete bypass fluid flows associated with operation of the underlying device as disclosed further below.

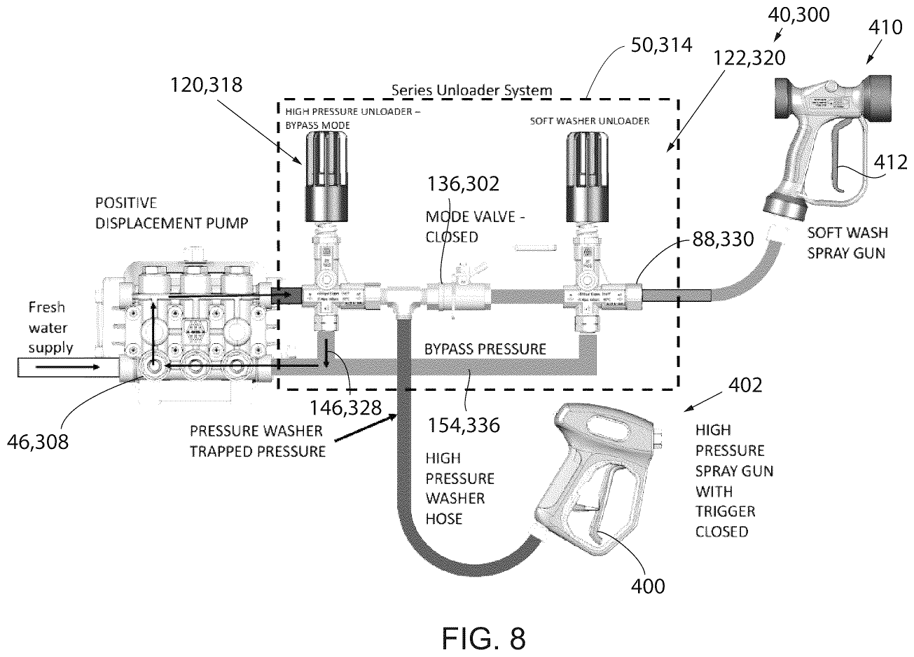

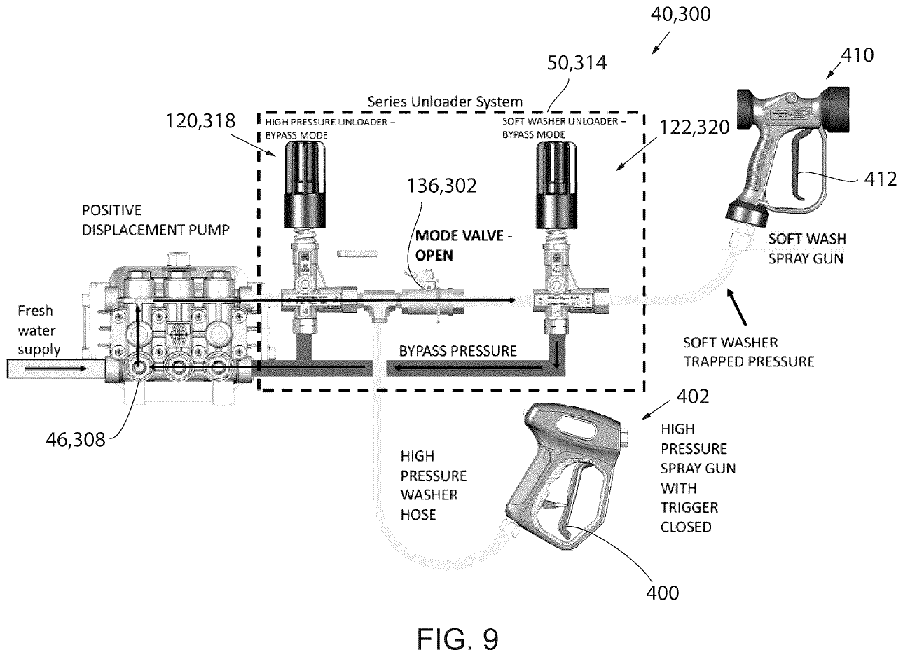

FIGS. 8-10 are various schematic views of pressure washer assemblies 40 and 300 as disclosed above with the respective discharge devices associated with the discrete high pressure and low pressure or soft wash or soap wash output thereof. Although shown with respect to pressure washer assemblies 40 and 300, it is appreciated that pressure washer assembly 200 is operable in a manner to the description below aside from user interaction with and manipulation of a second valve selector switch associated with facilitating soft wash or soap operations when desired. Referring to FIGS. 8 and 9, when high pressure washing is desired, mode selector valve 136, 302 is oriented in the “Closed” or “OFF” orientation such that the high pressure flow signal is communicated downstream of unloader valve assembly 120, 318 and toward high pressure discharge device 402. When a trigger 400 of pressure washing device 402 is non-actuated, the high pressure flow is contained in a hose 404 associated with the discharge device 402 such that a fluid flow associated with the high pressure wash is redirected to the respective pump assembly 46, 308 via the discrete bypass passages 146, 328. Upon actuation of trigger 400 and thereby discharge device 402, the fluid flow associated with high pressure unloader valve assembly 120, 318 is expelled from the fluid flow system via discharge device 402. Excess flow generated by unloader valve assembly 120, 318 is redirected upstream of unloader valve assembly 120, 318 and operates to limit the pressure communicated downstream thereof and to effectuate cooling of the pump rather than operation of the pump assembly 46, 308 at a trapped operating pressure. It should be further appreciated that, when valve assembly 136, 302 is oriented in the closed position as shown in FIG. 8, second unloader valve assembly 122, 320 and a soft wash discharge device 410 oriented downstream relative thereto, and fluidly isolated from the pressurized flow associated with operation of pressure washer assembly 40, 300.

When soft wash operations are desired, referring to FIG. 9, valve assembly 136, 302 is oriented in the “Open” or “ON” position such that, fluid flow output from first unloader valve assembly 120, 318 is communicated downstream and to second unloader valve assembly 122, 320. Once delivered thereto, second unloader valve assembly 122, 320 communicates a lower pressure flow to an outlet 88, 330 connectable to a low pressure or soft wash or soap discharge device 410. When a trigger 412 of soft wash discharge device 410 is unactuated, flow introduced to second valve unloader assembly 122, 320 returns via bypass passage 154, 336 to a location upstream of pump assembly 46, 308 for recirculation thereat. Upon actuation of trigger 412 of discharge device 410, the fluid flow associated with the discharge pressure of second unloader valve assembly 122, 320 is communicated to the discharge device 410 and usable for soft wash and/or soaping operations. It should be appreciated that pressure washer assembly 200 is operable in a manner similar to that described above with respect to FIGS. 8 and 9 albeit with the addition of and operation of the discrete operational mode selector valves (212, 214; FIG. 4) being position in the discrete “Open” or “ON” orientations to facilitate the selective isolation and/or communication of the desired working fluid flow to discrete wash mode output connectors 208, 210 as disclosed above.

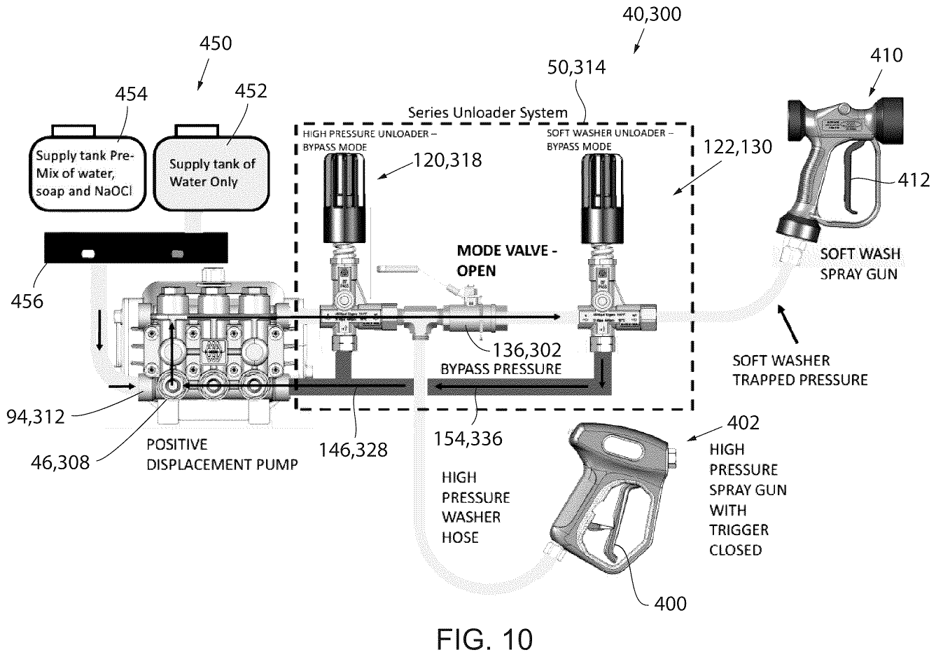

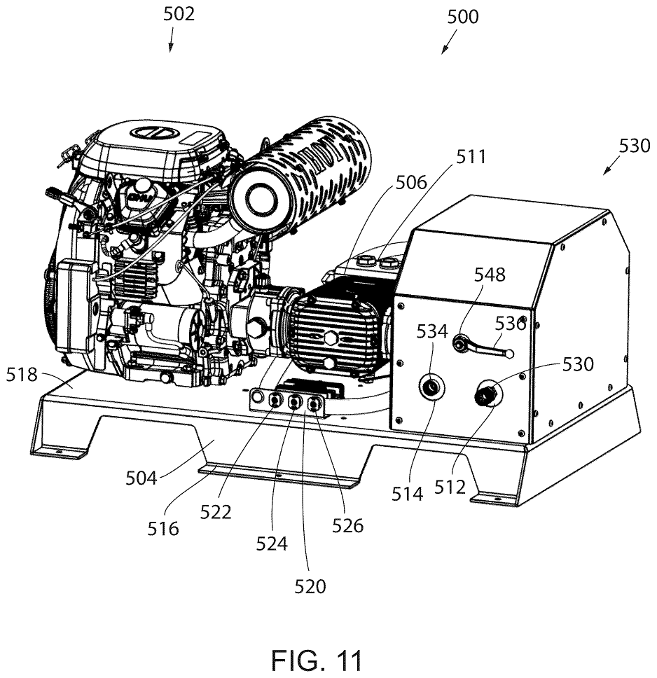

FIG. 10 shows a discrete schematic view similar to FIG. 9 wherein the use mode selector valve 136, 302 associate with the unloader valve assembly 50, 314 is oriented in the “Open” or “ON” orientation for use of the respective pressure washing assembly 40, 300 in a soft wash or soap washing modality. Although described with respect to power washer assemblies 50, 300; it should be appreciated that the following additional disclosure may be suitable for use with power washer assemblies 40, 300 as well as pressure washer assembly 200. Relative to FIG. 9, FIGS. 10 and 11 show the addition of an on-board solution supply 450 that can be fluidly connected to respective pressure washer assemblies 40, 200, 300. It is appreciated that the scope and nature of the cleaning operation to be undertaken, as well as the availability of municipality or well water within proximity to the cleaning operation, may render utilization of on-board solution supply 450 unnecessary for some application.

As shown in FIG. 10, on-board solution supply 450 can include a first reservoir 452 associated with containing a supply of water or the like and a second reservoir 454 associated with containing a supply of cleaning agent, such as bleach or other cleaning agents, and/or a mixture thereof with water. Solution supply 450, and the reservoirs 452, 454 associated therewith, are fluidly connected via a valve assembly 456 to inlet 94, 312 of pump assembly 46, 308 such that, during operation of the respective pressure washer assembly 40, 200, 300, a respective one of a wash water and/or a soaping solution or mixture can be delivered to the target surface via one or more discharge devices 402, 410 when desired. Preferably, during soft wash or soaping operations one or more of reservoirs 452, 454 can be delivered to discharge device 410 such that a soap or cleaning solution is expelled thereat. User interaction with valve assembly 456 allows solution supply 450 to be configured to dispense no solution when rinse water is available and/or utilize the contents of reservoir 452 when a supply of rinse water is available such that an on-board water supply can be employed for rinsing operations. Although shown as being introduced at the inlet of pump assembly 46, 308, it is further appreciated that cleaning solutions associated with solution supply 450 may be introduced downstream of pump assembly 46, 308 but upstream of respective unloader assemblies 50, 314 such that the respective cleaning agents remain usable for cleaning operations via with of discharge device 402 or discharge device 410 when desired.

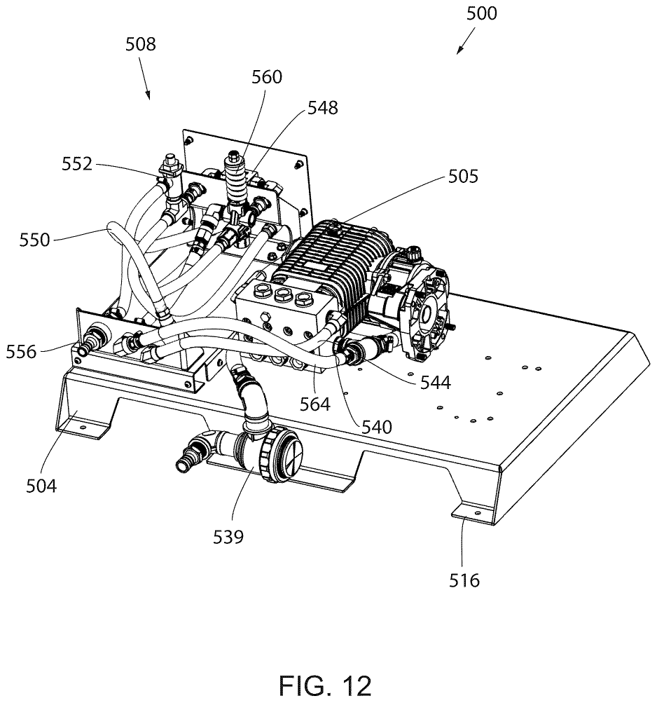

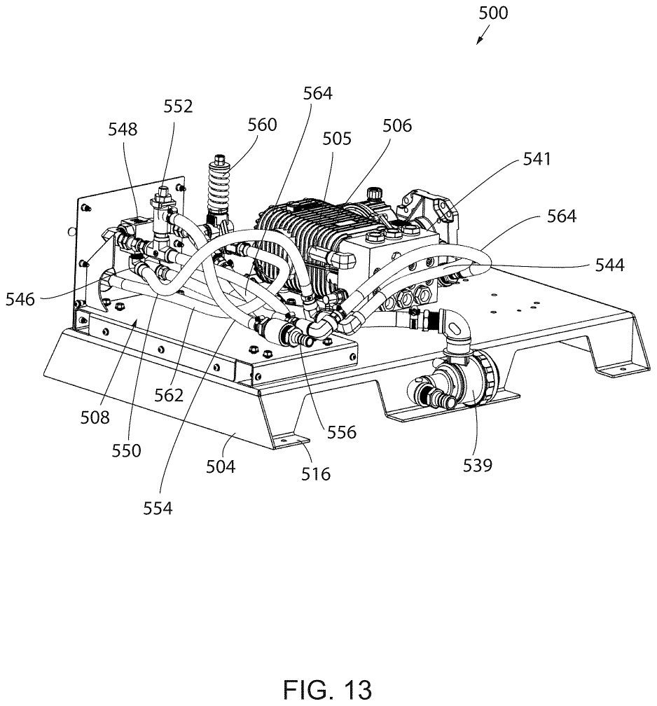

FIGS. 11-13 show various perspective views of a washing device or assembly, power washing device or assembly, or a pressure washer assembly 500 according to another embodiment of the present invention and which is also operable in a high pressure washing modality and a soft wash or soap modality. Referring to FIGS. 11-13, pressure washer assembly 500 includes a power plant, such as motor or an internal combustion engine 502, and is supported by a chassis 504. A pump assembly, such as a positive displacement pump assembly 506, is operationally connected to an output of engine 502. As disclosed further below, pump assembly 506 includes an output or outlet that communicates a pressurized fluid flow generated by operation of engine 502 and pump assembly 506 to a valve assembly 508 (FIGS. 12-13) that is constructed to communicate discrete working fluid flows to respective outlets 512, 514 (FIG. 11) of pressure washer assembly 500. Valve assembly 508 includes multiple discrete independently operable valve assemblies that are operationally connected to the working fluid flow path associated with pressure washer assembly 500. As disclosed further below, outlets 512, 514 are associated with providing each of a discrete pressure washing cleaning fluid flow and a soak or soft washing cleaning fluid flow during operation of pressure washer assembly 500.

As shown in FIGS. 11 and 12, chassis 504 includes a flange 516 formed at a downwardly facing portion thereof and which is shaped to facilitate mounting a chassis 504 relative to a transport vehicle-such as upon a truck bed and/or upon a trailer to facilitate the convenient transport of pressure washer assembly 500. As disclosed further below, it is further appreciated that chassis 504 may be constructed to accommodate respective wheels and/or a handle assembly associated with manual transport of pressure washer assembly 500 when desired. Engine 502, pump assembly 506, and/or valve assembly 508 are each preferably secured to an upward directed top surface 518 of chassis 504. A tip or nozzle flange 520 is secured to chassis 504 and is constructed to removably cooperate with one or more nozzles 522, 524, 526 in the same manner as nozzles 70, 72, 74, 76 as disclosed above and associated with utilization of a respective discharge or spray device, such as a wand or the like, during use of pressure washer assembly 500. A shroud assembly 530 generally extends about valve assembly 508 and is configured to minimize incidental contact with the components thereof. Outlet 512 is generally defined by a first quick coupler 530 that is accessible through a face plate 532 of shroud assembly 530 and is constructed to provide a tool-lessly removable connection of a pressure spray hose therewith. A second quick coupler 534 is disposed proximate first quick coupler 530 and is constructed to accommodate removable connection of a soft wash hose therewith. A valve handle 536 is associated with faceplate 532 and is positioned approximate quick couplers 530, 534 and is operable to facilitate selective utilization and/or the communication of a desired working fluid flow to the respective quick connector 530, 534 associated with the high pressure washing operational modality and the soft washing operational modality during use of pressure washer assembly 500.

Referring to FIGS. 12-14, pump assembly 506 includes a pump manifold having an inlet 540 that is constructed to be connected to a fluid supply source such as those disclosed above. It is appreciated that the fluid supply source can be provided by utility or well water supplies and/or an on-board or proximate tank supply of working water and/or cleaning agents carried on the flow associated therewith. In a preferred embodiment, an optional filter assembly 539 is provided between a source or supply of working fluid, whether water and/or a water and cleaning agent flow, and inlet 540 of manifold 541 associated with pump assembly 506. Inlet 540 is preferably associated with a T-fitting which is configured to communicate supply source fluid to inlet 540 as well as any bypass flows, indicated by hose 564, generated by the valve assembly of pressure washer assembly 500 during operation thereof as disclosed further below. In a preferred embodiment, manifold 541 includes a pressure relief valve 505 that is constructed and connected to manifold 541 to limit the operating pressure that can achieved during operation of pump assembly 506. Although not shown above, it is appreciated each of pressure washing assemblies 40, 200, 300; and more specifically the respective manifolds of the respective pump assemblies thereof, could also include pressure relief valve 505.

Like pressure relief valve 505, it is further appreciated that filter assembly 539 can be similarly employed with pressure washer assemblies 40, 200, 300 disclosed above when desired. Regardless of the origin and type of the working fluid being supplied, pump assembly 506 communicates the working fluid supply flow communicated to pump assembly 506 as a pressurized fluid flow to a pump discharge outlet 544. Unlike pressure washer assemblies 40, 200, 300 described above, fluid from pump discharge outlet 544 is communicated to an inlet 546 (FIG. 13) of wash mode selector valve 548 via a hose 550. When selector valve 548 of pressure washer assembly 500 is positioned for soft or soap wash operations, the flow associated with pump discharge outlet 544 is communicated to an unloader valve assembly in the form of what can be referred to as a pressure relief valve 552 of valve assembly 508. Pressure relief valve 552 is constructed to communicate a desired flow and pressure of working fluid flow to low pressure or soft wash/soap wash connector 534 for use thereat for cleaning operations. As disclosed further below, when a trigger of a discharge device is actuated or open fluid flow is directed through pressure relief valve 552 thereto. When the discharge device is not actuated, a portion of the fluid flow delivered to pressure relief valve 552 beyond a desired operating pressure associated with operation of the discharge device is directed to a bypass passage or a pressure relief passage and returned to a supply or to inlet of pump manifold 541. In a preferred aspect, pressure relief valve 552 is constructed to communicate no greater than 1000 PSI, more preferably less than 800 PSI, and more preferably no greater than approximately 80 PSI to the soft wash connector 514 and the discharge device associated therewith when soft wash mode operations are desired. It should further be noted that, when wash mode selector valve 548 is oriented to effectuate fluid communication to pressure relief valve 552 associated with soaping or soft wash operations, a unloader valve assembly 560 associated with high pressure washing operations is fluidly isolated from the fluid flows associated the soft wash operations. Such a consideration allows unloader valve 560 and the respective hoses and discharge devices associated therewith, to the fluidly isolated from the fluid flows, and any cleaning agents associated therewith, from being communicated therethrough and thereby mitigates chemical damage to those portions of power washer assembly associated with high pressure cleaning operations.

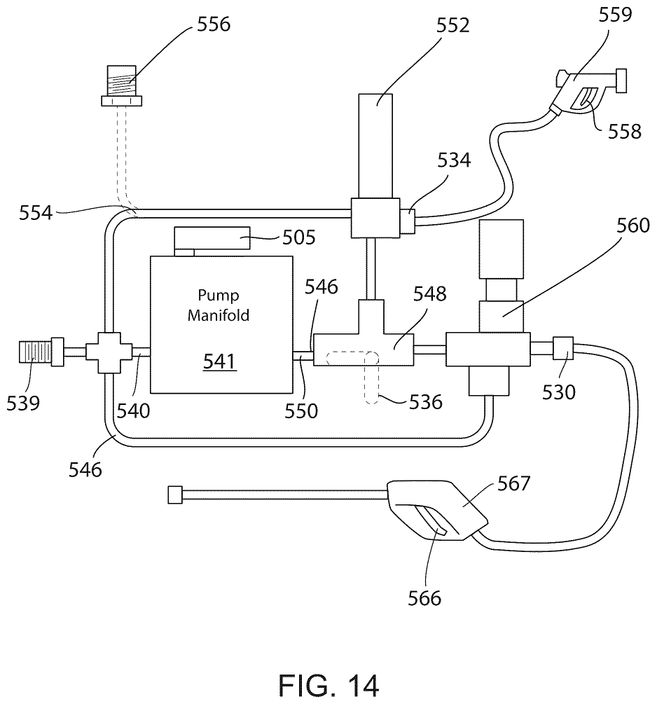

Pressure relief valve 552 includes a bypass passage 554 that is directed to an outlet 556 that communicates any excess flow and pressure that is communicated to pressure relief valve 552 from manifold 541 to a source or supply of working fluid flow associated with operation of pressure washer assembly 500. As indicated in FIG. 14, and as disclosed above with respect to pressure washer assemblies 40, 200, 300, it is appreciated that outlet 556 associated with soft wash pressure relief valve 552 could be configured to communicate excess fluid flow to a bulk source, such as a tank or the like, or returned to inlet 540 of manifold 541 of pump assembly 506 for subsequent recirculation through valve assembly 508 for subsequent cleaning operations. When configured for soft wash operations, pressure relief valve 552 maintains a desired soft wash flow at soft wash quick connector 534 such that, during actuation of a trigger 558 (FIG. 14) associated with a wand 559 (FIG. 14) or other cleaning device, the lower pressure cleaning flow is communicated thereto and discharged therefrom. Preferably, pressure relief valve 552 includes an outlet nozzle associated with a discharge side of the valve and that is internal thereto. The outlet nozzle is preferably calibrated to maintain a desired back pressure thereat such that the pressure relief valve maintains an “open” condition of a desired flow pressure to soft wash outlet 514 when trigger 558 associated with discharge device 559 is oriented in a “closed” condition such that discharge device 559 remains available for utilization of soft washing operations as trigger 558 is periodically actuated and released. Preferably, the calibrated nozzle of pressure relief valve 552 is sized such that the internal pressure of the pressure relief valve is at least slightly greater than the operating pressure associated with a nozzle on the spray gun, wand, or discharge device 559 thereby increasing the internal pressure of relief valve 552 to a value that is greater in force than the bias associated with the spring keep the valve closed while operating the spray gun. Such a consideration mitigates pulsatile or surge effects associated with utilization of soft wash discharge device 559 associated with larger flow nozzle configurations being associated therewith. When trigger 558 associated with discharge device 559 is not actuated, while a desired pressure remains present at discharge device 559, excess flow directed to pressure relief valve 552 is directed to the fluid source supply and/or inlet 540 of manifold 541 thereby preventing over pressurization of the fluid flow communicated to soft wash quick connector 534 and/or a respective discharge device 559 associated therewith.

When high pressure washing activities are desired, wash mode selector valve assembly 548 is oriented in a pressure wash position and configured to communicate the fluid flow directed to valve assembly 548 to high pressure unloader valve assembly 560 associated with high pressure washing connector 512. The fluid flow directed to high pressure unloader valve assembly 560 is communicated therefrom via a high pressure hose 562 to high pressure washing quick connecter 530 and/or to a wand or other pressure washing device 567 (FIG. 14) connected thereto. When mode selector valve assembly 548 is oriented in the high pressure washing selection and no high pressure working fluid flow is being discharged from pressure washer assembly 500, such as during non-actuation of a trigger 566 (FIG. 14) or the like associated with discharge device 567 (FIG. 14) such as a wand or the like, flow directed to unloader valve assembly 560 is communicated via a bypass passage 564 that extends between high pressure unloader valve assembly 560 and communicates any excess flow therefrom to inlet 540 of manifold 544. As described above with respect to pressure washer assemblies 40, 200, 300; such a consideration prevents communication of excessive pressures to high pressure outlet 512 and/or quick connector 530 and facilitates cooling of manifold 541, pump assembly 506, and valve assembly 508 during those periods when engine 402 is operating but no working fluid flow is being utilized for either of high pressure washing operations and/or soft washing operations.

Although disclosed as being manually operable valve assemblies, it is appreciated that one or more of the valves associated with selectively configuring one or more of pressure washer assemblies 50, 200, 300, 500 for high pressure washing cleaning modalities, lower pressure washing cleaning modalities, soaping cleaning operations, rinsing operations, and selective utilization of on-board or municipal or well water supply intakes can be effectuated in methodologies other than manually operating valve arrangements as shown. For instance, it is appreciated that one or more of the discrete manually operable valve assemblies associated with configuring the discrete pressure washer assemblies 40, 200, 300, 500 and/or solution supply could be electronically, servo-electrically, and/or electromechanically operable or the like. That is, it is envisioned that user inaction with common area control system can be employed to configure the underlying pressure washer device 40, 200, 300, 500 for operation in high pressure with or without soap cleaning modality, lower pressure with or without soap cleaning modality, a designation and/or selection of the origin of the water source as on-board or off-board, and/or a designation of a cleaning agent when employed for soaping operations. Regardless of the configuration of the underlying pressure washer assembly 40, 200, 300. 500 and the provision of on-board or off board water supplies, each of pressure washer assemblies 40, 200, 300, 500 provide a power washer assembly that can be configured to provide a high pressure washing modality and a low pressure soaping or washing cleaning modality. It is further appreciated that although each of pressure washer assemblies 40, 200, 300, 500 is configured to deliver two discrete and dissimilar pressurized working fluid flows; one or more of pressure washer assemblies 40, 200, 300, or 500; and more specifically the discrete series unloader valve assemblies 50, 202, and/or 314; and/or low pressure unloader valve or pressure relief valve 552 and high pressure unloader valve of valve assembly 508 could be constructed to include more than two discrete unloader valve assemblies, pressure relief valve assemblies; and/or combinations thereof such as pressure washer assembly 500, wherein each discrete unloader valve assembly and/or low pressure unloader valve assembly or pressure relief valve assembly is configured to communicate a discrete working fluid flow pressure to a discrete discharge device whose operating mode is attenuate to the working fluid flow pressures communicated thereto.

In a preferred aspect, respective first unloader valve assemblies 120, 230, 318, 560 communicate a pressurized working fluid flow to a respective discharge device fluidly connected thereto that is preferably no less than 99 psi and preferably no greater than 8000 psi. More preferably, the working fluid flow communicated to the respective discharge device associated therewith is between about 1200 psi and about 7000 psi. Those skilled in the art will appreciate that working fluid flows associated with respective first unloader valve assemblies are provided in pressure and flow ranges typical to what is considered suitable for high pressure washing operations. Similarly, respective second unloader valves 122, 232, 320 and/or low pressure unloader valve assemblies and/or pressure relief valve assembly 552 communicate a pressurized working fluid flow to a respective discharge device associated therewith and that is preferably no less that than 20 psi and preferably no greater than 1000 psi. More preferably, the working fluid flow communicated to the respective discharge device associated therewith is between about 50 psi and about 400 psi. Those skilled in the art will appreciate that working fluid flows associated with respective second unloader valve assemblies and/or low pressure unloader valve assemblies and/or pressure relief valve assembly 552 are provided in pressure and flow ranges typical to what is considered suitable for soft and/or soap wash operations. As alluded to above, when respective pressure washer assemblies 40, 200, 300, 500 are provided with a third unloader valve and/or one or more discrete pressure relief valves, associated with the respective series unloader valve assemblies 50, 202, 314; and/or respective pressure relief valves; such an assembly is configured to provide yet another working fluid flow that can be provided at pressures and/or flows that are between and/or outside the respective upper and lower working fluid flows pressures mentioned above and thereby providing a pressure washer assembly that can be configured to be operable in one or more of a high pressure wash modality; a low, higher, or mid pressure wash modality; and a soak, soap, or soft wash modality. It is further appreciated that each of pressure washer assemblies 40, 200, 300, 500 could be configured to provide the discrete working fluid flows in either of a selectively usable manner and/or configurations wherein the discrete working fluid flows are concurrently available and/or usable at the same times as other working fluid flows. It should be further understood that use of the respective terms “first”, “second”, “third”, etc. in the disclosure above indicate the discrete numbers of respective parts, components, and/or systems associated with each of pressure washer assemblies 40, 200, 300, and 500. Applicant's use of the relative numerical terms and should not be misconstrued to designate any respective assignment and/or interpretation related to the sequence of fluid flows through the discrete pressure washer assemblies 40, 200, 300, and 500 during operation thereof that would contradict or be contrary to the disclosure above. That is, use of the relative numerical terms “first”, “second”, “third”, etc. can similarly be interpreted as “one, another, another, etc.” and has no import to the direction or sequencing of the discrete flows between discrete components.

Therefore, one embodiment of the present invention defines a pressure washer assembly that is operable in multiple modalities and includes a pump assembly that communicates a pressurized flow to a valve assembly. The valve assembly includes a pressure relief valve and an unloader valve assembly. The pressure relief valve assembly is configured to generate a first pressurized fluid flow and the unloader valve assembly is configured to generate a second fluid flow at a considerably higher pressure than a pressure associated with the first pressurized fluid flow. The first pressurized fluid flow is suitable for lower pressure or soft-wash, or soaping, operations associated with use of the underlying pressure washer assembly whereas the second pressurized fluid flow is suitable for pressure washing operations.

Another embodiment of the invention that is useable or combinable with one or more of the features, aspects, or objects of the above embodiment includes a power washer assembly having a pump that defines a pump inlet that is connectable to a fluid supply and is configured to communicate fluid to a pump outlet during operation of the pump. A pressure relief valve and an unloader valve assembly are each disposed downstream of the pump outlet. The pressure relief valve and the unloader valve assembly are further constructed to operate at different pressures relative to one another. A first outlet is associated with the pressure relief valve and is operable at a first pressure and a second outlet is associated with the unloader valve assembly and is operable at a second pressure that is higher than the first pressure associated with the first outlet.

A further embodiment of the invention that is usable or combinable with one or more features, aspects, or objects of the above embodiments includes a pressure washer assembly having a positive displacement pump. A selectively operable valve assembly is disposed between an outlet of the positive displacement pump and a pressure relief valve and an unloader valve assembly. The pressure relief valve is configured to generate a first pressurized flow during operation of the positive displacement pump and the unloader valve assembly is configured to generate a second pressurized flow that is different than the first pressurized flow during operation of the positive displacement pump. The selectively operable valve is selectively operable to direct flow from the output of the positive displacement pump to one of the pressure relief valve and the unloader valve.

Another embodiment of the invention that is usable or combinable with one or more features, aspects, or objects of the above embodiments includes a method of providing a portable pressure washer assembly that is operable to generate multiple output pressures. The method includes providing a pump that is configured to communicate a fluid flow from a pump inlet to a pump outlet during operation of the pump. The pump outlet is connected to a valve that is operable to direct flow delivered from the pump outlet to one of a pressure relief valve that is configured to generate a first pressurized flow and an unloader valve that is configured to generate a second pressurized flow that is different than the first pressurized flow.

The present invention has been described in terms of the preferred embodiments. The embodiments disclosed herein are directed to the assembly as generally shown in the drawings. It is recognized that equivalents, alternatives, and modifications, aside from those expressly stated, to the embodiments summarized, or the embodiment shown in the drawings, are possible and within the scope of the appending claims. The appending claims cover all such alternatives and equivalents.

What is claimed is:

1. A power washer assembly comprising:
a pump having a pump inlet that is connectable to a fluid supply and is configured to communicate fluid to a pump outlet during operation of the pump;
an unloader valve disposed downstream of the pump outlet;
a pressure relief valve disposed in a parallel flow stream relative to the unloader valve and wherein the unloader valve and the pressure relief valve operate at different pressures relative to one another;
a first outlet associated with the unloader valve and operable at a first pressure; and
a second outlet associated with the pressure relief valve and that is operable as a second pressure that is lower than the first pressure associated with the first outlet.

2. The power washer assembly of claim 1 further comprising a valve disposed between the unloader valve and the pressure relief valve.

3. The power washer assembly of claim 2 wherein the valve is manually operable.

4. The power washer assembly of claim 1 further comprising a quick release coupler associated with the first outlet and another quick release coupler associated with the second outlet.

5. The power washer assembly of claim 4 further comprising a pressure hose constructed to cooperate with at least one of the quick release coupler and the another quick release coupler.

6. The power washer assembly of claim 5 further comprising a wand connected to the pressure hose.

7. The power washer assembly of claim 1 further comprising a power source connected to the pump.

8. The power washer assembly of claim 7 wherein the power source is further defined as least one of an internal combustion engine and a motor.

9. The power washer assembly of claim 7 further comprising a chassis that supports the pump and the power source.

10. The power washer assembly of claim 1 further comprising a bypass that fluidly connects the unloader valve to at least one of the pump and the fluid supply and another bypass that fluidly connects the pressure relief valve to at least one of the pump and the fluid supply.

11. The power washer assembly of claim 1 further comprising a valve disposed between the pump outlet and each of the pressure relief valve and the unloader valve and operable to selectively direct flow from the pump outlet to one of the pressure relief valve and the unloader valve.

12. A pressure washer assembly comprising:
a positive displacement pump;
a selectively operable valve assembly disposed between an output of the positive displacement pump and a pressure relief valve that is configured to generate a first pressurized flow and an unloader valve that is configured to generate a second pressurized flow that is different than the first pressurized flow; and
wherein the selectively operable valve assembly is selectively operable to direct fluid flow from the output of the positive displacement pump to one of the pressure relief valve and the unloader valve.

13. The pressure washer assembly of claim 12 wherein the valve is manually operable.

14. The pressure washer assembly of claim 12 further comprising at least one tank that is connected to an input of the positive displacement pump.

15. The pressure washer assembly of claim 14 wherein the at least one tank is further defined as at least one of a water tank and a cleaning mixture tank.

16. The pressure washer assembly of claim 12 further comprising a bypass passage between the pressure relief valve and the positive displacement pump.

17. The pressure washer assembly of claim 16 further comprising another bypass passage between the unloader valve and the positive displacement pump.

18. The pressure washer assembly of claim 12 further comprising at least one of an internal combustion engine and an electric motor connected to the positive displacement pump.

19. The pressure washer assembly of claim 12 further comprising a first output configured to be connected to a pressure washer wand operable at the first pressurized flow pressure and a second output configured to be connected to another pressure washer wand and operable at the second pressurized flow pressure.

20. A method of providing a portable pressure washer that is operable to generate multiple output pressures, the method comprising:
providing a pump configured to communicate a fluid flow from a pump inlet to a pump outlet during operation of the pump; and
connecting the pump outlet to a valve that is operable to direct flow delivered from the pump outlet to one of a pressure relief valve that is configured to generate a first pressurized flow and an unloader valve that is configured to generate a second pressurized flow that is different than the first pressured flow.

21. The method of claim 20 further comprising connecting one of an internal combustion engine and an electric motor to the pump.

22. The method of claim 20 further comprising orienting flows associated with the pressure relief valve and the unloader valve in parallel with one another downstream of the valve.

23. The method of claim 20 further comprising providing a bypass passage from the pressure relief valve to at least one of back to the pump and a location upstream of the pump inlet and another bypass passage from the unloader valve to at least one of back to the pump and a location upstream of the pump inlet.

24. The method of claim 23 wherein the location upstream of the pump inlet is further defined as a supply tank.

25. The method of claim 20 further comprising providing a quick connector associated with an output of the pressure relief valve and another quick connector associated with an output of the unloader valve.

26. The method of claim 20 further comprising providing a pressure hose connectable to at least one of an output of the pressure relief valve and an output of the unloader valve.

27. The method of claim 26 further comprising providing a pressure washer wand that is connectable to the pressure hose.

28. The method of claim 20 further comprising providing at least one of a water tank and a cleaning solution tank whose contents can be communicated to at least one of the first pressurized flow and the second pressurized flow during operation of the pump.

29. A cleaning system comprising:
a power source connected to a pump;
an outlet of the pump communicating a fluid flow to one of a pressure relief valve and an unloader valve assembly wherein the unloader valve assembly operates at a higher pressure than the pressure relief valve; and
disposing a valve between the outlet of the pump and each of the pressure relief valve and the unloader valve assembly.
